(19) United States
(12) Patent Application Publication
(10) Pub. No.: US 2010/0295702 A1
(43) Pub. Date: Nov. 25, 2010

(54) High Speed Telemetry Full-Duplex Pre-Equalized OFDM Over Wireline for Downhole Communication

(75) Inventors: Jinsong Zhao, Houston, TX (US); Harold Andrade, The Woodlands, TX (US); Jorge O. Maxit, Houston, TX (US); Raman Viswanathan, Houston, TX (US)

Correspondence Address: Mossman, Kumar and Tyler, PC, P.O. Box 421239, Houston, TX, 77242, US

(73) Assignee: Baker Hughes Incorporated, Houston, TX (US)

(21) Appl. No.: 12/781,675

(22) Filed: May 17, 2010

Related U.S. Application Data
(60) Provisional application No. 61/179,988, filed on May 20, 2009.

(51) Int. Cl. G01V 3/00

(52) U.S. Cl. 340/855.4; 340/853.1

(57) ABSTRACT

A Full-Duplex Pre-equalized OFDM system for high speed telemetry down-hole wire-line communication. The system compensates for the narrow bandwidth, high attenuation of, and noise in a downhole wireline using Trellis Code Modulation and Reed Solomon encoding.

### CROSS-REFERENCES TO RELATED APPLICATIONS

This application claims priority from U.S. Provisional Patent Application Ser. No. 61/179,988 filed on May 20, 2009.

### BACKGROUND OF THE DISCLOSURE

1. Field of the Disclosure

The present disclosure is related to the field of electric wireline well logging tools. More specifically, the present disclosure is related to systems for two way communication of signals between logging tools disposed in wellbores and a recording and control system located at the earth's surface

2. Background of the Art

Electric wireline well logging tools are used to make measurements of certain properties of earth formations penetrated by wellbores. The measurements can assist the wellbore operator in determining the presence, and quantity if present, of oil and gas within subterranean reservoirs located within the earth formations.

Well logging tools known in the art are typically extended into the wellbore at one end of an armored electrical cable. The cable includes at least one, and commonly includes as many as seven, insulated electrical conductors surrounded by steel armor wires. The armor wires are included to provide abrasion resistance and tensile strength to the cable also provide the mechanical strength to suspend logging instruments in the borehole. The cable supplies electrical power to the logging tools and provides a communication channel for signals sent between the logging tools and a recording system usually located near the wellbore at the earth's surface.

Logging tools known in the art can provide many different types of measurements of the earth formation properties, including measurements of electrical resistivity, natural gamma-ray radiation intensity, bulk density, hydrogen nucleus concentration and acoustic travel time, among others. Still other logging tools, generally called “imaging” tools, provide finely detailed measurements, meaning successive measurements can be made at axial and radial spacings of as little as several hundredths of an inch, of resistivity and acoustic pulse-echo travel time in order to generate a graphic representation of the visual appearance of the wall of the wellbore.

It is generally beneficial to the wellbore operator to be able to combine as many different types of logging tools as is practical into one continuous instrument package (generally called a “tool string” by those skilled in the art). The benefit to the operator is to reduce the number of times logging tools must be extended into the wellbore, which can save a considerable amount of operating time. Combining a large number of measurements generally requires that large amounts of signal data be sent to the recording system at the earth's surface.

A particular problem in combining large numbers of measurements in the tool string is that the large amount of signal data which must be transmitted can cause the required signal data transmission rates to exceed the signal carrying capacity of the cable. This problem is particularly acute when the imaging tools are included in the tool string because of the very fine measurement spacing, and consequently the large increase in the amount of signal data, of imaging tools relative to other types of tools.

Conventional cables are used for two-way transmission of signals in addition to supplying power to the downhole logging tool assembly. The upward communication comprises the data recorded by the individual logging tools while the downward communication comprises control commands to the logging tools. The control commands may include instructions for setting the parameters used in the tools. Some prior art devices rely on the half-duplex mode wherein at any one time, only one way communication is possible. This is inefficient and leads to a decrease in the total throughput of the communications links.

Orthogonal Frequency Division Multiplexing (OFDM) has been widely used in the telecommunication industry for Asymmetric Digital Subscriber Lines. The present disclosure addresses the problems with implementing OFDM for the problems of communication through a cable into a borehole.

### SUMMARY OF THE DISCLOSURE

One embodiment of the disclosure is a method of communicating information through a downhole cable. The method includes: selecting a plurality of channels for communicating the information; simultaneously encoding and modulating the information at a first end of the cable; receiving signals at a second end of the cable responsive to the encoded and modulated information; and demodulating and decoding the received signals to provide an estimate of the information.

Another embodiment of the disclosure is a system for communicating information through a downhole cable. The system includes: a first processor configured to simultaneously encode and modulate the information at a first end of the cable in a plurality of channels; a receiver at a second end of the cable configured to receive signals responsive to the encoded and modulated information in the cable; and a second processor configured at the second end of the cable configured to demodulate and decode the received signals to provide an estimate of the information.

### BRIEF DESCRIPTION OF THE DRAWINGS

The present disclosure is best understood with reference to the accompanying figures in which like numerals refer to like elements and in which:

FIGS. 1a-1f (Prior Art) show cross-sections of commonly used wirelines for logging applications;

FIG. 2 shows a well logging tool lowered into a wellbore penetrating an earth formation;

FIG. 3 shows an exemplary frequency response of a wireline cable;

FIG. 4 shows a functional block diagram of some of the important features of the present method and system;

FIG. 5 illustrates the partitioning of the available bandwidth into a plurality of sub-carriers;

FIG. 6 schematically illustrates the types of noises;

FIG. 7a shows an exemplary constellation for TCM in the present disclosure;

FIG. 7b shows a block diagram of the TCM encoding process showing the convolutional coding and set partitioning;

FIG. 8 illustrates the concept of pre-equalization; and

FIG. 9 shows the effect of channel dispersion without (a) and with (b) the use of a prefix with the signals;

### DETAILED DESCRIPTION OF THE DISCLOSURE

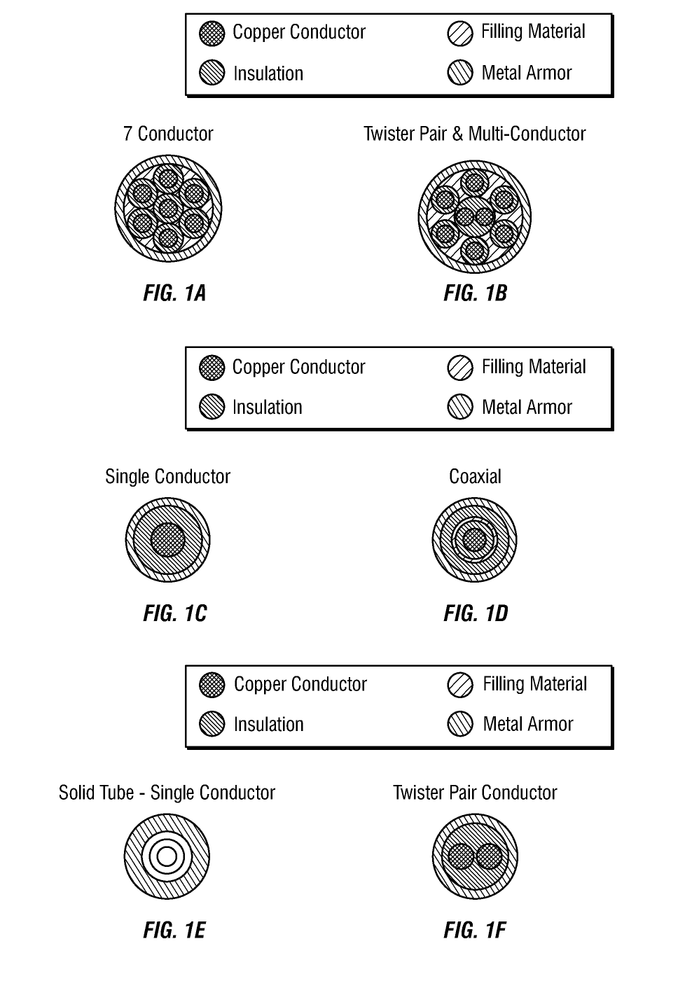

FIGS. 1a-1f show cross-sections of commonly used logging wirelines, the most common being the 7 conductor cable of FIG. 1a. The existing cables are designed for the mechanical strength and not optimized for signal transmission. Present well logging instruments employing advanced technology generate large amount of data. Large investments are in place to support the present cables. The cable may have limited signal transmission capacity because it is designed for mechanical strength not signal transmission capability.

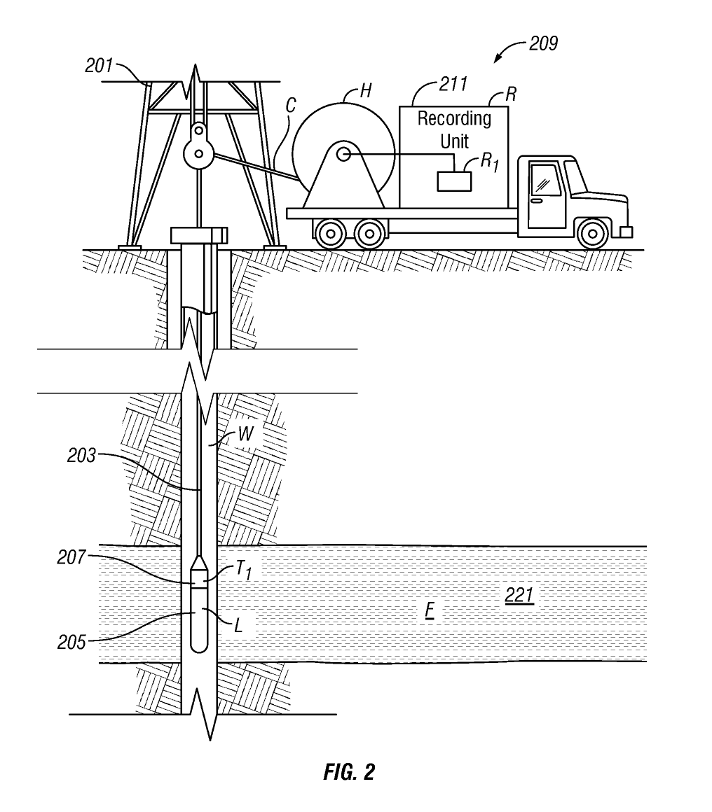

FIG. 2 shows an exemplary arrangement in which the method and apparatus of the present disclosure may be used. Shown is a recording truck 209 that deploys a cable (wireline) 203 into a well W in the earth formation. The wireline has a logging tool 205 that includes formation evaluation (FE) sensors that make measurements of one or more properties of an earth formation such as 221. Included in the logging tool is a transmitter/receiver 207 that is configured for two way communication through the wireline 203 with a surface transmitter/receiver R1 in the recording truck. A surface processor 211 is configured to handle the communications between the surface transmitter/receiver R1 and the downhole transmitter/receiver 205.

Communications sent from the surface to the downhole location primarily comprise instructions for control of the logging tool 205: its depth, rate of movement, and the control of the FE sensors on the logging tool. Communications from the downhole location to the surface comprise the measurements made by the formation evaluation sensors along with information regarding the location and orientation of the logging tool 205 corresponding to the measurements made by the FE sensors.

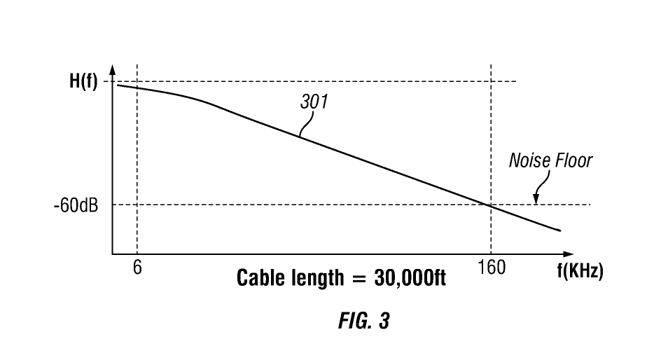

FIG. 3 shows an exemplary frequency response of a wireline cable of length 30,000 ft (9144 m). Defining a noise floor at −60 dB referenced to the low frequency response, it can be seen that the useful bandwidth of the cable is about 160 Hz. The noise floor is determined by the fact that the wireline cable is also used for power transmission from the surface to the logging tool. Any communication through the cable is limited to this bandwidth. In addition to the high attenuation that gives rise to the low bandwidth, the cable is also dispersive. The dispersion over 20,000 ft (6096 m) is, in an exemplary case, 26 μs, so that the communication system has to be designed with this dispersion in mind Additionally, the downhole transmitter/receiver has limited signal power due to the fact that it is powered by the wireline cable.

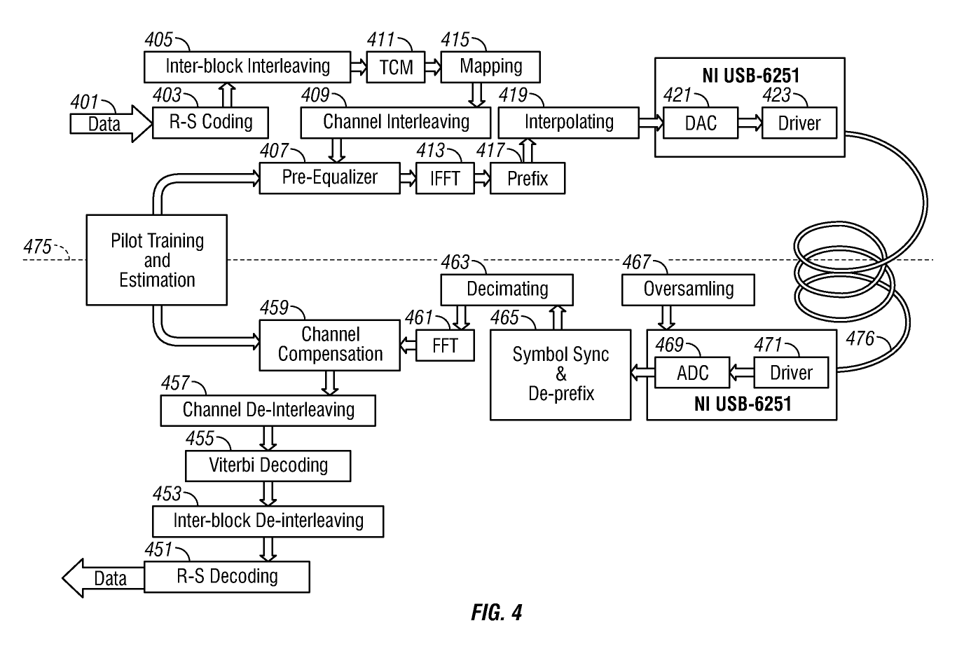

FIG. 4 shows a functional block diagram of some of the components of the communication system of the present disclosure. Reference will be made to this figure throughout this document while discussing the details of the method and system. A point to note that in this figure, elements above the line 475 refer to the transmitter components while elements below the line refer to the receiver components. The communication channel (wireline) is depicted by 476. As noted above, there is a transmitter at the surface and downhole locations and there is a receiver at the surface and downhole locations.

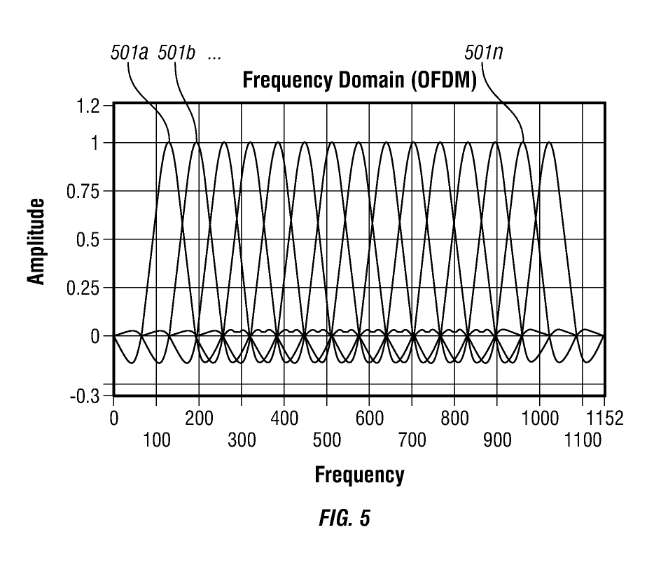

The basic approach taken here is to use Orthogonal Frequency Domain Multiplexing (OFDM). In OFDM a large number of closely-spaced orthogonal sub-carriers are used to carry data. The data is divided into several parallel data streams or channels, one for each sub-carrier. Each sub-carrier is modulated with a conventional modulation scheme (such as quadrature amplitude modulation or phase shift keying) at a low symbol rate, maintaining total data rates similar to conventional single-carrier modulation schemes in the same bandwidth. This is illustrated in FIG. 5 where the available bandwidth is covered by a plurality of sub-carriers 501a, 501b . . . 501n. What is shown in FIG. 5 is the concept of Frequency Division Multiplexing. The Orthogonality results from the manner in which the signals in each of the sub-carriers are modulated. This is described later in this document. In one embodiment of the disclosure, 60 channels, each with a bandwidth of 2 kHz, are used, giving a frequency range from 4 kHz to 124 kHz. As described below, OFDM involves a joint design of channel codes and modulation. This joint design of channel codes and modulation allows using relative simple channel codes. This joint channel coding and modulation scheme is known as trellis coded modulation (TCM).

OFDM has a number of benefits. The multiplexing with minimal overlap means that the available spectral bandwidth is efficiently used. The orthogonality results in low interference between the sub-carriers. The narrow bandwidth of the individual sub-carriers makes the system robust with respect to narrow band noise: only a few sub-carriers would be affected by the noise. No equalization of the signal levels in the different sub-carriers is necessary. The method is also characterized by a low symbol rate (SR), which results in low inter-symbol interference (ISI). Another advantage of OFDM is that the core calculations can be implemented using a Fast Fourier Transform (FFT) or an Inverse Fast Fourier Transform (IFFT): operations that can be implemented using the limited capabilities of a downhole processor. Specific problems associated with implementation of OFDM for communication between a surface location and a downhole location through a wireline cable are discussed next.

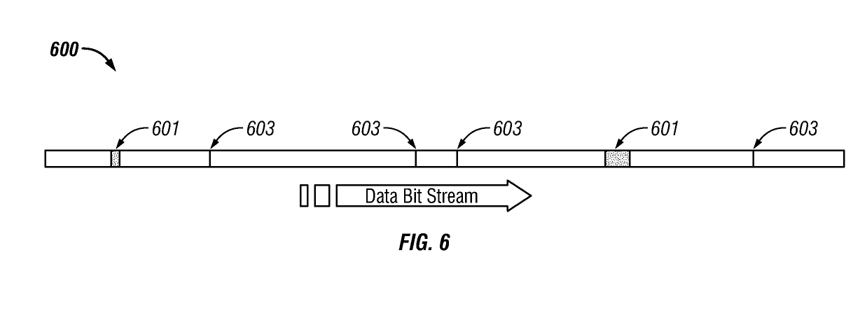

Referring now to FIG. 6, two different types of noises are shown that affect a data stream 600. The noises denoted by 601 are called Random Burst Bit Errors. They are called “bursts” because they affect a relatively large portion of the bitstream. They are called random because they occur at random intervals. The noises denoted by 603 are called Random Isolated Bit Errors. They typically affect only one bit of the data stream. The present system includes methodology for dealing with each type of noise.

Referring now to FIG. 4, in order to deal with Burst Bit Errors in the data stream to be transmitted 401, Reed-Solomon 403 coding is used. Reed-Solomon error correction is an error-correcting code that works by oversampling a polynomial constructed from the data. The polynomial is evaluated at several points, and these values are sent or recorded. Sampling the polynomial more often than is necessary makes the polynomial over-determined. As long as it receives “many” of the points correctly, the receiver can recover the original polynomial even in the presence of a “few” bad points.

Reed-Solomon codes are block codes. This means that a fixed block of input data is processed into a fixed block of output data. In the case of the most commonly used R-S code (255, 223)—223 Reed-Solomon input symbols (each eight bits long) are encoded into 255 output symbols. Corresponding the R-S coding 403 at the transmitter, there is an R-S decoding in the receiver 451, the output of which is the recovered data stream.

An inherent limitation of digital processing systems is that data can be read (or transmitted) faster than it can be processed. For this reason, interleaving is provided in the system 405. What this means is that the blocks of data coming from the R-S coding are not sequentially arranged; instead, they are interleaved. This ensures that during the time a block of data is being processed, a number of blocks are temporarily bypassed and the next block that is accessed by the processor is the block that sequentially follows the block being processed. As a counterpart to the interleaving 405, there is a de-interleaving 453 in the receiver.

Still referring to FIG. 4 and referring again to FIG. 6, in order to deal with isolated bit errors, the present disclosure uses a Trellis Code Modulation (TCM) 411, 415. TCM is discussed with respect to a mud-pulse telemetry system in U.S. patent application Ser. No. 12/190,430 of Li, having the same assignee as the present disclosure and the contents of which are incorporated herein by reference. As discussed by Li, to increase the data rate in a communication, the number of modulation signals may be increased, e.g., from 2 (binary) to 4 (quadrature), at the cost of increase of error rate. To decrease the error rate, redundancy may be introduced by applying the channel coding at the cost of reduction of data rate. To increase the data rate without increase of the error rate, a channel code may be designed that has a sufficient coding gain to overcome the penalty from the increase of the number of modulation signals. Such a channel code could be a convolution code with large memory length or a block code with large block length, when channel codes and modulation are designed separately. As a result, the coding system could be complex and computationally expensive. As an alternative, jointly designing channel codes and modulation allows using relative simple channel codes to achieve the same goal. This joint channel coding and modulation scheme is known as trellis coded modulation (TCM).

Fundamental to TCM is the concept of a constellation. For the purposes of the present disclosure, we adopt the definition given in Wikipedia. A constellation diagram is a representation of a signal modulated by a digital modulation scheme such as quadrature amplitude modulation or phase-shift keying. It displays the signal as a two-dimensional scatter diagram in the complex plane at symbol sampling instants. In a more abstract sense, it represents the possible symbols that may be selected by a given modulation scheme as points in the complex plane. Measured constellation diagrams can be used to recognize the type of interference and distortion in a signal. The term “constellation” is defined as the entire ensemble of signals possible with a particular modulation method. For the present disclosure, the modulation may include Phase-Shift Keying and Amplitude Shift keying.

As noted in Ungerboeck (1982), Signal waveforms representing information sequences are most impervious to noise-induced detection errors if they are very different from each other. Mathematically, this translates into the requirement that signal sequences should have large distance in Euclidean signal space. The essential new concept of TCM that led to the aforementioned gains was to use signal-set expansion to provide redundancy for coding, and to design coding and signal-mapping functions jointly so as to maximize directly the “free distance” (minimum Euclidean distance) between coded signal sequences. This allowed the construction of modulation codes whose free distance significantly exceeded the minimum distance between uncoded modulation signals, at the same information rate, bandwidth, and signal power. The term “trellis” is used because these schemes can be described by a state-transition (trellis) diagram similar to the trellis diagrams of binary convolutional codes. The difference is that in TCM schemes, the trellis branches are labeled with redundant nonbinary modulation signals rather than with binary code symbols.

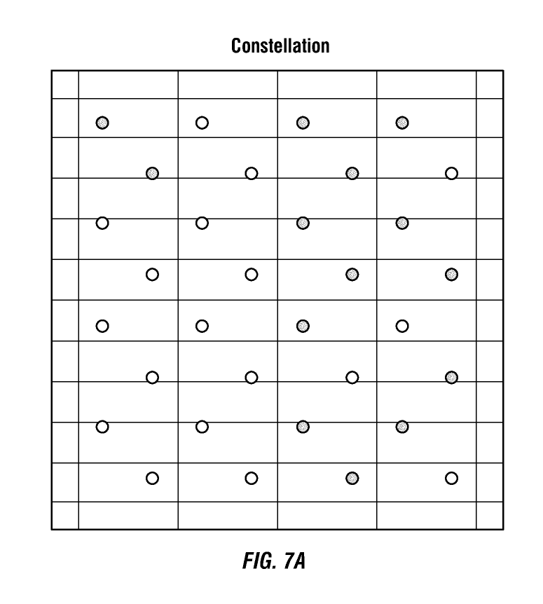

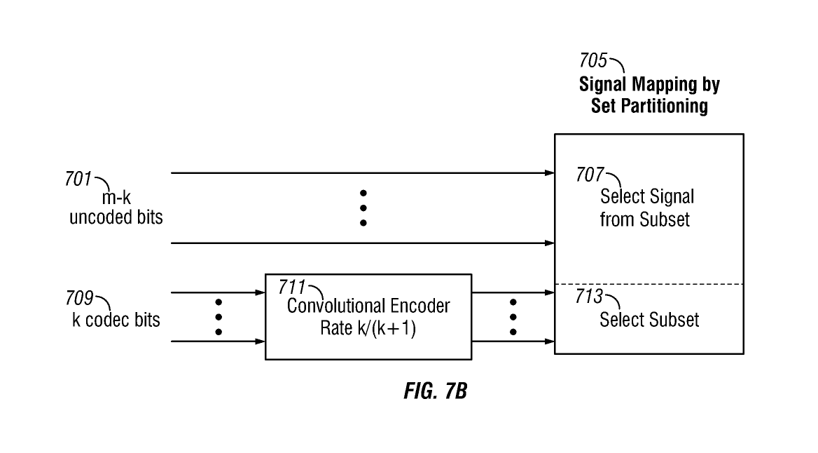

FIG. 7a shows an exemplary constellation used with the present disclosure. The number of points in the constellation is a function of the signal-to-noise ratio. This means that the lower numbered channels (corresponding to lower frequencies) will have more elements in the constellation than the higher numbered channels. The design of TCM can be interpreted in terms of the convolutional coding with the set partitioning of signal constellations. This is illustrated in FIG. 7b. Given a block of m information bits input to the TCM, k≧m bits 309 are input to a rate k/(k+1) convolutional encoder 711 and its outputs are used to select one of 2k+1 set-partitioning subsets of a redundant signal constellation with 2m+1 signal points. The uncoded (m−k) bits 701 are used to select one of 2m−k signal points in the subset to be transmitted. The output bits of the convolutional encoder 711 are used to select a subset in the second level 713 of set partitioning 705 of the signal constellation. The uncoded bits are used to select signal points in the subset 707. The number of bits per symbol depends upon the signal to noise ratio for the channel and is typically between 10 and 4, with an average value of around 7.

Returning to FIG. 4, the result of the TCM (411) is a mapping 415 of the signals into the space defined by the modulating signals. The reverse operation in the receiver is accomplished by the Viterbi decoding 455. This is followed by an interleaving 414 of the channels The interleaving of the channels is necessitated by the different channels having different capacities. The reverse operation in the receiver is the de-interleaving 457.

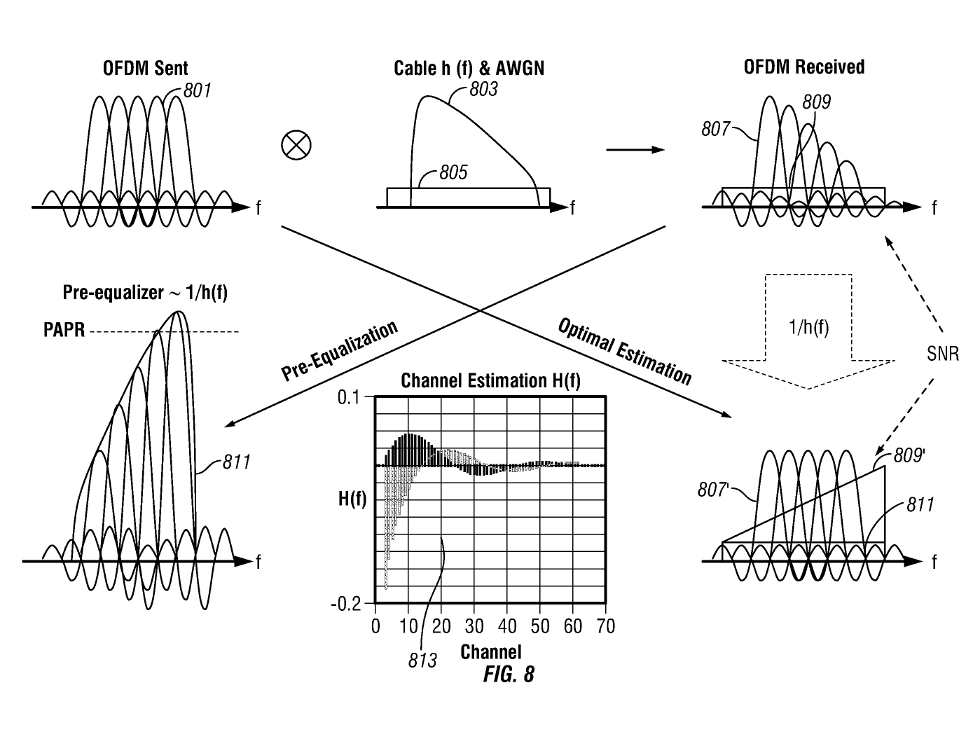

A pre-equalization of the signals is done 407. The pre-equalization is discussed with reference to FIG. 8. Shown therein is an exemplary OFDM 801 with a uniform spectral distribution. Upon passage through a cable having a spectral response h(f) (denoted by 803) and additive white noise 805, the received OFDM would have a spectral distribution 807 and additive noise 809. If the received signal is bandpassed using a function 1/h(f), the result would be and OFDM with a spectrum 807′, i.e., the spectrum is equalized. However, the noise gets boosted at the high frequencies to give the spectrum 809′.

With pre-equalization, the spectral correction is done at the transmitter, so that the OFDM has a spectrum shown by 811. A resulting change in a time-domain signal is indicated by 813 and the received OFDM spectrum is 807′. The noise spectrum is now 811, i.e., flat.

Returning to FIG. 4, an inverse Fourier Transform is implemented as an inverse Fast Fourier Transform. This converts the digital time domain signal into a form suitable for analog transmission (the reverse operation in the receiver is the FFT at 461).

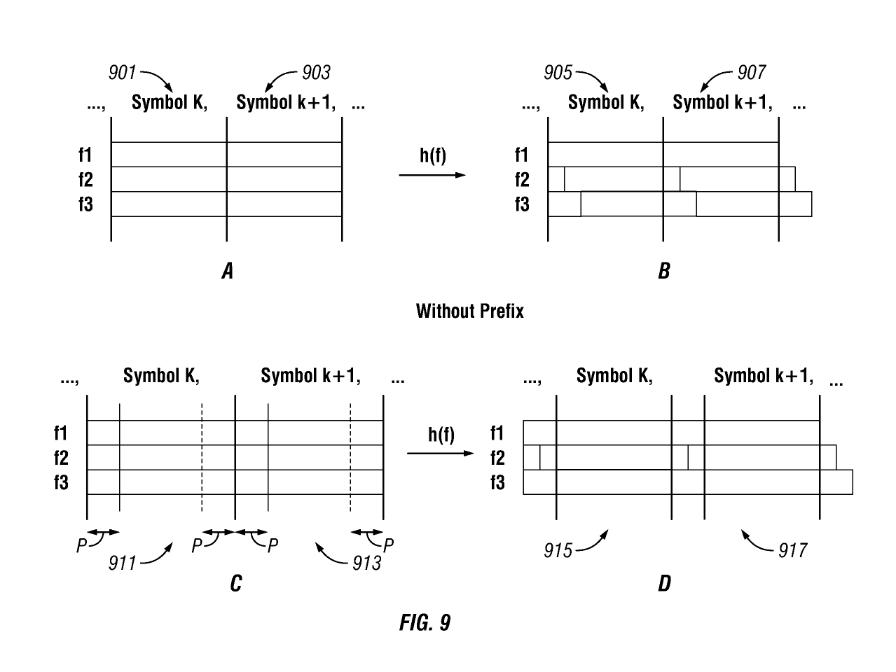

Next, a prefix is added to the signals. This is necessary due to the dispersive nature of the communication channel and the resulting frequency-dependent time delay. This is best understood with reference to FIG. 9. Shown in FIG. 9a are symbols k 901 and k+1 901 for three different frequencies. No prefixes are used. After propagating through a dispersive channel, as seen at 905, the symbol k at the lowest frequency f₁ is properly registered within the time interval for the symbol. However, due to channel delay, at frequency f₂, the symbol k overlaps into symbol k+1, and at frequency f₃, the overlap is even greater. This basically means that the received signal is corrupted, and any attempt to decode the contents of a symbol at a selected frequency are likely to fail. The prefix length is determined based on the estimated delay in the wireline. In one embodiment of the disclosure, a prefix length of 40 μs is used.

FIG. 9b shows that the generated symbol length has been increased by adding a prefix p at the beginning and end of each symbol, so that the symbol k 911 is longer than the symbol 901, and the symbol 913 is longer than the symbol 903. After passing through the communication channel with the delay, the result is shown in 915 and 917. Also shown are intervals corresponding to the original symbol length. It can be seen that at all three of the frequencies, the received symbol is not corrupted by signal from other frequencies.

The reverse operation in the receiver is denoted in FIG. 4 by 465. In this, the prefix is removed so that the symbols now have a reduced length. The synchronization is obtained by sending a pilot pattern as part of a training process 475 and performing a cross-correlation.

An interpolation of the data is done 417. In one embodiment of the disclosure, this involves an upsampling by a factor of 4. A first order Lagrange interpolation may be used. This upsampling reduces problems with the Digital to Analog converter (DAC) 421 caused by transitions between successive symbols. The output of the DAC 421 is sent to the communications driver 423 and on to the wireline 475. The output of a driver 471 in the receiver is fed to the Analog to Digital Converter (ADC) 469. The output of the ADC is oversampled to avoid problems caused by transitions before being sent to the symbol synchronization and de-prefixing 465. The decimating 463 brings the data back to 128 samples in the time domain.

The channel compensation 459 removes the channel gain on the symbol signals in the frequency domain.

It should be noted that the communication between the surface location and the downhole location could be in a simplex mode, a half duplex mode and/or a full duplex mode as the terms are understood in the art.

The operation of the transmitter and receivers may be controlled by the downhole processor and/or the surface processor. The modulation/encoding and demodulation/decoding are done by the downhole processor and the surface processor respectively Implicit in the control and processing of the data is the use of a computer program on a suitable machine readable medium that enables the processor to perform the control and processing. The machine readable medium may include ROMs, EPROMs, EAROMs, Flash Memories and Optical disks. The results of the processing include telemetry signal estimates relating to measurements made by downhole formation evaluation sensors. Such results are commonly stored on a suitable medium and may be used for further actions in reservoir development such as the completion of wells and the drilling of additional wells.

What is claimed is:

1. A method of communicating information through a downhole cable, the method comprising:
selecting a plurality of channels for communicating the information;
simultaneously encoding and modulating the information at a first end of the cable;
receiving signals at a second end of the cable responsive to the encoded and modulated information; and
demodulating and decoding the received signals to provide an estimate of the information.

2. The method of claim 1 wherein the first end of the cable is at a downhole location and the information comprises a measurement made by a sensor.

3. The method of claim 1 further comprising using the encoded modulated information to generate a signal in each of the plurality of channels wherein the signal in at least one of the plurality of channels is substantially orthogonal to the signal in each of the plurality of channels other than the at least one channel.

4. The method of claim 3 wherein the simultaneous encoding and modulating further comprises:
(i) partitioning a set of bits representative of the information into a first subset and a second subset,
(ii) conveying the first subset of the information to a convolutional encoder and using the output of the convolutional encoder to define a first subset of an encoded modulated signal; and
(iii) using the second subset of the information to define a second subset of an encoded modulated signal.

5. The method of claim 1 wherein the modulation is at least one of: (i) a Phase-Shift Keying, and (ii) an Amplitude Shift keying.

6. The method of claim 1 wherein the encoding information further comprises using a Reed-Solomon code to mitigate effects of random bust error in the cable.

7. The method of claim 3 further comprising equalizing the signals in each of the channels using a measured frequency attenuation of the cable.

8. The method of claim 3 further comprising adding a prefix to each symbol in each channel, a length of the prefix being determined by a delay in the cable between the first end of the cable and the second end of the cable.

9. The method of claim 3 wherein the generation of the signals is in a mode selected from: (i) a simplex mode, (ii) a half duplex mode, and (iii) a full duplex mode.

10. A system for communicating information through a downhole cable, the system comprising:
a first processor configured to simultaneously encode and modulate the information at a first end of the cable in a plurality of channels;
a receiver at a second end of the cable configured to receive signals responsive to the encoded and modulated information in the cable; and
a second processor configured at the second end of the cable configured to demodulate and decode the received signals to provide an estimate of the information.

11. The system of claim 10 wherein the first end of the cable is at a downhole location, the system and the information further comprises a measurement made by a sensor.

12. The system of claim 10 wherein the first processor is further configured to simultaneously encode and modulate the information at the first end of the cable by generating a signal in at least one of the plurality of channels that is substantially orthogonal to the signal in each of the plurality of channels other than the at least one channel.

13. The system of claim 10 wherein the first processor is configured to produce the encoded modulated signal by further:
(i) partitioning a set of bits representative of the information into a first subset and a second subset,
(ii) conveying the first subset of the information to a convolutional encoder and using the output of the convolutional encoder to define a first subset of an encoded modulated signal; and
(iv) using the second subset of the information to define a second subset of the encoded modulated signal.

14. The system of claim 10 wherein the first processor is configured to perform the modulation by performing at least one of: (i) a Phase-Shift Keying, and (ii) an Amplitude Shift keying.

15. The system of claim 10 wherein the first processor is further configured to encode the information using a Reed-Solomon code to mitigate effects of random burst error in the cable.

16. The system of claim 10 wherein the first processor is further configured to equalize the signals in each of the channels using a measured frequency attenuation of the cable.

17. The system of claim 10 wherein the first processor is further configured to add a prefix to each symbol in each channel, a length of the prefix being determined by a delay in the cable between the downhole location and the surface location.

18. The system of claim 10 wherein the second processor is configured to demodulate and decode the received signal by further using a Viterbi algorithm.

19. A computer-readable medium product having stored thereon instructions that when read by at least one processor cause the at least one processor to execute a method, the method comprising:
communicating information through a downhole cable from a downhole location to a surface location by:
selecting a plurality of channels for communicating the information; and
simultaneously encoding and modulating the information at the downhole location and transmitting the encoded and modulated information to a surface location for further processing.

20. The computer-readable medium product of claim 19 further comprising at least one of: (i) a ROM, (ii) an EPROM, (iii) an EAROM, (iv) a flash memory, and (v) an optical disk.
